(19) United States
(12) Patent Application Publication
(10) Pub. No.: US 2008/0030094 A1
(43) Pub. Date: Feb. 7, 2008

(54) DYNAMOELECTRIC MACHINE ROTOR AND METHOD FOR REDUCING TORQUE RIPPLE

(75) Inventors: William Cai, Carmel, IN (US); David Fulton, Anderson, IN (US)

Correspondence Address: CANTOR COLBURN, LLP, 55 GRIFFIN ROAD SOUTH, BLOOMFIELD, CT, 06002, US

(73) Assignee: REMY INTERNATIONAL, INC., Anderson, IN (US)

(21) Appl. No.: 11/832,029

(22) Filed: Aug. 1, 2007

Related U.S. Application Data
(60) Provisional application No. 60/835,811, filed on Aug. 4, 2006.

(51) Int. Cl. H02K 1/27; H02K 15/03

(52) U.S. Cl. 310/156.01; 29/598; 310/261

(57) ABSTRACT

Disclosed herein is a dynamoelectric machine rotor. The rotor includes, a plurality of first cavities positioned near a circumferential surface of the rotor, each first cavity receptive of at least one permanent magnet, and a plurality of second cavities positioned substantially between circumferentially adjacent first cavities.

### CROSS REFERENCE TO RELATED APPLICATION

This application is a non-provisional application of U.S. Ser. No. 60/835,811, Aug. 4, 2006, the contents of which are incorporated by reference herein in their entirety.

### BACKGROUND OF THE INVENTION

Dyanmoelectric machines often use permanent magnets positioned within a rotor that rotates within a central bore of a stator to convert mechanical energy to electrical energy and vice versa.

Magnetic flux lines extend between poles of opposing polarity within the individual permanent magnets as well as between adjacent permanent magnets. The paths and density of these magnetic flux lines can have a significant effect on the relationship of torque versus rotational angle of the rotor of the dynamoelectric machine. For example, uneven distribution of flux lines around the perimeter of the rotor can result in higher and lower levels of torque, often referred to as torque ripple, experienced during rotation of the rotor in the dynamoelectric machine. Such torque ripple may be undesirable for several reasons, such as, audible noise, loss of efficiency, and increased component wear, for example.

The paths that the flux lines follow are determined, in part, by materials positioned between and around the opposing poles and the geometry of such materials. Flux lines position themselves preferentially within soft magnetic materials as opposed to hard magnetic materials and material voids. Therefore, rotor design can have a significant effect on the flux line paths generated.

Accordingly, improvements in the art of rotor design that reduce torque ripple and the side effects associated therewith are desirable in the art.

### BRIEF DESCRIPTION OF THE INVENTION

Disclosed herein is a dynamoelectric machine rotor. The rotor includes, a plurality of first cavities positioned near a circumferential surface of the rotor, each first cavity receptive of at least one permanent magnet, and a plurality of second cavities positioned substantially between circumferentially adjacent first cavities.

Further disclose herein is a dynamoelectric machine rotor assembly. The assembly includes, a rotor, a plurality of first cavities formed within the rotor near a circumferential surface thereof, a plurality of permanent magnets, each one of the plurality of permanent magnets being fixedly attached to the rotor within one of the plurality of first cavities, and a plurality of second cavities formed within the rotor, each of the plurality of second cavities being positioned between circumferentially adjacent first cavities.

Further disclosed herein is a method for minimizing torque ripple of a dynamoelectric machine. The method includes, inhibiting natural flux line formation while a rotor of the dynamoelectric machine is in motion by interrupting selected regions of the rotor prone to flux passage by interpositing one or more cavities in the region, and directing flux lines around the one or more cavities in the rotor.

Further disclosed herein in a method of making a rotor for a dynamoelectric machine. The method includes, forming a rotor with a plurality of first holes receptive of magnets and a plurality of second holes for sculpting flux lines.

### BRIEF DESCRIPTION OF THE DRAWINGS

The following descriptions should not be considered limiting in any way. With reference to the accompanying drawings, like elements are numbered alike:

FIG. 1 depicts a partial cross sectional view of a dynamoelectric machine depicted herein.

### DETAILED DESCRIPTION OF THE INVENTION

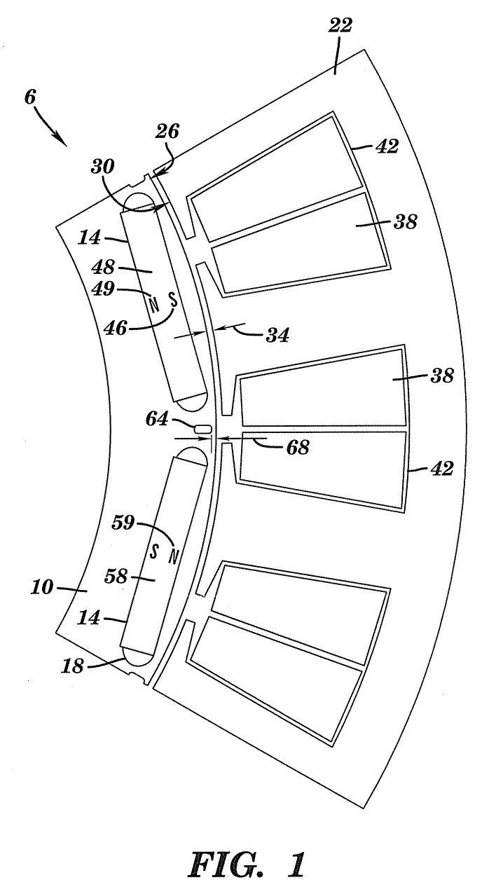

Referring to FIG. 1, a partial cross sectional view of a dynamoelectric machine 6 disclosed herein is depicted. A rotor 10 has permanent magnets 14 fixedly positioned within first cavities 18 formed therein. The rotor 10 is located concentrically within a stator 22 and rotates about a rotor axis (not shown). Clearance between an outer circumferential surface 26 of the rotor 10 and an inner circumferential surface 30 of the stator 22 form a radial air gap 34 therebetween. The air gap 34 is intentionally kept small to maximize performance of the dynamoelectric machine 6.

The stator 22 includes wound coils 38 fixedly positioned within slots 42 formed therein. The coils 38 are wound from an insulated conducting material such as copper, for example. Electric current is passed through the coils 38 of the stator 22 to generate magnetic fields that react with the magnetic fields of the permanent magnets 14 of the rotor 10 during conversion of energy by the dynamoelectric machine 6. Such conversion of energy can be from mechanical to electrical or from electrical to mechanical, for example. Performance and efficiency of the energy conversion is partially dependent upon the shape and distribution of flux lines from the permanent magnets 14 of the rotor 10.

The magnetic field of the permanent magnets 14 is shaped, in part, by the material and geometry of the rotor 10. Magnetic flux lines tend to concentrate in soft magnetic materials and tend to avoid hard magnetic materials and material voids, such as air pockets and cavities or cavities with non-magnetic fillers, in the soft magnetic material. The rotor 10 is, therefore, intentionally made of a soft magnetic material, such as silicon steel or powdered metal, for example, to allow the flux lines to be shaped by the geometric shape of the rotor 10.

Magnetic flux lines extend between magnetic poles of opposite polarity. For example, flux lines extend between a south (S) pole 46, of a first magnet 48, and a north (N) pole 49, of the first magnet 48, and simultaneously the leakage flux lines extend between the S pole 46, of the first magnet 48, and an N pole 59 of a second magnet 58. The amount of rotor material located between the adjacent poles 46 and 59 will have an effect on the routing of the flux lines between the poles 46 and 59 and the strength of the magnetic field in that area of the rotor 10. Consequently, the geometric design of the rotor 10 can influence the strength of the magnetic fields around the perimeter of the rotor 10 resulting in areas with locally stronger and locally weaker magnetic fields.

Having locally stronger and locally weaker magnetic fields around the perimeter of the rotor 10 can cause variations in torque of the dynamoelectric machine 6 as the rotor 10 is rotated relative to the stator 22. Such a variation in torque is commonly known as torque ripple. Torque ripple can cause variations in rotational speed of the rotor 10 within each complete rotation of the rotor 10, for example. Such variations in rotational speed can cause increases a rate of wear of components such as drive belts and bearings for example. Torque ripple can also cause vibration and undesirable audible noise to be emitted from the dynamoelectric machine 6. Additionally, torque ripple has been shown to have a detrimental affect on efficiency of dynamoelectric machines. Consequently, it is often desirable to decrease variations in the magnetic field around the perimeter of the rotor 10 and thereby decrease torque ripple associated therewith.

As mentioned above, flux lines tend to avoid cavities formed in a soft magnetic material. As such, careful positioning of cavities in a soft magnetic material can be used to beneficially sculpt magnetic flux lines to optimize energy transfer and minimize torque ripple. A second cavity 64, disclosed herein, is positioned in an area where flux lines tend to be shorted. More specifically, the second cavity 64 is positioned in the rotor 10 between two adjacent poles 46 and 59. Such a positioning of the second cavity 64 causes flux lines to route around the second cavity 64 thereby elongating the path length of the flux lines and decreasing the total flux lines that would otherwise be shorted. The second cavity 64 can therefore be used to increase a uniformity of the magnetic field strength around the perimeter of the rotor 10. Such an increase in uniformity of the magnetic field strength about the perimeter of the rotor 10 can decrease the magnitude of torque ripple and the problems, mentioned above, associated therewith. The second cavity 64 increases uniformity of magnetic strength by reducing a number of flux lines shorted between the adjacent poles 46, 59 within the rotor 10. The cavity 64 forces more flux lines to pass through the air-gap 34 where they link with the flux lines of the magnetic field of generated by the stator coil 38. Interactions between flux from the permanent magnets 14 and flux from the stator coils 38 is a key factor in efficient electromechanical energy conversion.

Though the second cavity 64 need not extend fully through the axial length of the rotor 10, embodiments wherein the second cavity 64 does extend fully through the rotor 10 may be desirable to create axial symmetry of the second cavity 64 relative to the magnets 14. In the circumferential direction the second cavity 64, as shown, is symmetrical. Such a design may provide uniformity of magnetic strength regardless of the rotational direction of travel of the rotor 10 and may therefore be preferred for applications where rotation in either direction is desirable. Alternatively, for applications wherein the rotor 10 travels in only a single rotational direction an asymmetrical second cavity may be desirable. Such an asymmetrical second cavity may provide for a more uniform flux line distribution and correspondingly reduced torque ripple in one direction as opposed to the opposite direction.

Radial positioning of the second cavities 64 within the rotor 10 will also effect routing of flux lines. The second cavities 64 should be positioned as close to the circumferential surface 26 as feasible without actually being connected to the surface 26, thereby leaving a bridge 68 of soft magnetic material between the second cavities 64 and the surface 26. The bridge 68 should be so thin that it is saturated with flux lines thereby diverting additional flux lines through the air gap 34 and into the stator 22. The bridge 68 should be thick enough, however, to maintain structural integrity even subsequent to a machining operation if a machining operation is utilized as discussed below. The presence of the bridge 68, as opposed to connecting the second cavity 64 to the surface 26, as a notch or groove, presents a continuous circumferential surface 26. The continuous nature of the circumferential surface 26 significantly improves the machinability of the surface 26 while extending longevity of cutting tools used thereon.

Machining of the surface 26 can be desirable to remove local protrusions and depressions that may be present in the surface 26 subsequent to the manufacture of the rotor 10. Such a machining operation may take place on a lathe, for example, and can improve the concentricity of the circumferential surface 26 with an axis of rotation of the rotor 10. Such improved rotor concentricity may allow for a smaller air gap 34 and an associated improvement in efficiency. The rotor 10 may be manufactured in different ways, one of which is by stacking and fixing together several individual and substantially identical laminations. Such laminations may be made by stamping them from a sheet of metal, for example. Another method of manufacture involves compression of a powdered metal and subsequent sintering of the powdered metal to form the rotor 10 into a solid stack. The laminations or solid stack, in this embodiment, are made with the first cavities 18 and second cavities 64 formed therein. Axial alignment of the cavities 18 and 64 is, therefore, controlled during the manufacturing process. In the lamination example the lamination stacking process for the rotor 10 controls the alignment of the laminations to one another, which can affect a size of any protrusions or depressions resulting in the circumferential surface 26. Regardless of the manufacturing method used to fabricate the rotor 10 local protrusions and depressions may be present in a size that would be desirable to be removed by a subsequent machining process.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A dynamoelectric machine rotor, comprising:
a plurality of first cavities positioned near a circumferential surface of the rotor, each first cavity receptive of at least one permanent magnet; and
a plurality of second cavities positioned substantially between circumferentially adjacent first cavities.

2. The dynamoelectric machine rotor of claim 1, wherein the rotor is made of a soft magnetic material.

3. The dynamoelectric machine rotor of claim 1, wherein the plurality of second cavities extend fully through an axial length of the rotor.

4. The dynamoelectric machine rotor of claim 1, wherein the plurality of second cavities are enclosed within the rotor and do not connect to the circumferential surface of the rotor.

5. The dynamoelectric machine rotor of claim 1, wherein the plurality of second cavities are circumferentially symmetrical.

6. The dynamoelectric machine rotor of claim 1, wherein the plurality of second cavities are circumferentially asymmetrical.

7. The dynamoelectric machine rotor of claim 1, wherein each of the plurality of second cavities are positioned substantially symmetrically between circumferentially adjacent first cavities.

8. A dynamoelectric machine rotor assembly, comprising:
a rotor;
a plurality of first cavities formed within the rotor near a circumferential surface thereof;
a plurality of permanent magnets, each one of the plurality of permanent magnets being fixedly attached to the rotor within one of the plurality of first cavities; and
a plurality of second cavities formed within the rotor, each of the plurality of second cavities being positioned between circumferentially adjacent first cavities.

9. The dynamoelectric machine rotor assembly of claim 8, wherein the rotor is made of a soft magnetic material.

10. The dynamoelectric machine rotor assembly of claim 8, wherein the plurality of second cavities extend fully through an axial length of the rotor.

11. The dynamoelectric machine rotor assembly of claim 8, wherein the plurality of second cavities are enclosed within the rotor and do not connect to the circumferential surface of the rotor.

12. The dynamoelectric machine rotor assembly of claim 8, wherein the second cavities extend axially a full length of the rotor.

13. The dynamoelectric machine rotor assembly of claim 8, wherein the plurality of second cavities are circumferentially symmetrical.

14. The dynamoelectric machine rotor assembly of claim 8, wherein the plurality of second cavities are circumferentially asymmetrical.

15. The dynamoelectric machine rotor assembly of claim 8, wherein each of the plurality of second cavities is positioned substantially symmetrically between circumferentially adjacent first cavities.

16. A method for minimizing torque ripple of a dynamoelectric machine, comprising:
inhibiting natural flux line formation while a rotor of the dynamoelectric machine is in motion by interrupting selected regions of the rotor prone to flux passage by interpositing one or more cavities in the region; and
directing flux lines around the one or more cavities in the rotor.

17. The method of claim 16, further comprising positioning the cavities between circumferentially adjacent permanent magnets.

18. A method of making a rotor for a dynamoelectric machine, comprising:
forming a rotor with a plurality of first holes receptive of magnets and a plurality of second holes for sculpting flux lines.

19. The method of claim 18, further comprising compressing and sintering powdered metal in the forming of the rotor.

20. The method of claim 18, further comprising:
stamping laminations from sheets; and
stacking and fixing the laminations to one another with the first holes aligned axially and the second holes aligned axially in the forming of the rotor.
